(19) United States
(12) Patent Application Publication
(10) Pub. No.: US 2015/0361514 A1
(43) Pub. Date: Dec. 17, 2015

(54) Methods For Preserving Untanned Animal Hides

(71) Applicant: The United States of America, as represented by the Secretary of Agriculture, Washington, DC (US)

(72) Inventor: Mila Ramos, Soudertown, PA (US)

(21) Appl. No.: 14/740,761

(22) Filed: Jun. 16, 2015

Related U.S. Application Data
(60) Provisional application No. 62/013,194, filed on Jun. 17, 2014.

(51) Int. Cl. C14C 1/00

(52) U.S. Cl. CPC C14C 1/00

(57) ABSTRACT

Methods for preserving untanned animal hides involving contacting the hides with an aqueous suspension containing glycerol, sodium carbonate (and/or sodium bicarbonate), polyethylene glycol, and less than about 20% salt (W/W).

### REFERENCE TO RELATED APPLICATION

This application claims the benefit of U.S. Provisional Application No. 62/013,194, filed 17 Jun. 2014, which is incorporated herein by reference in its entirety.

### BACKGROUND OF THE INVENTION

Methods for preserving untanned animal hides involving contacting the hides with an aqueous suspension containing glycerol, sodium carbonate (and/or sodium bicarbonate), polyethylene glycol, and less than about 25% salt (W/W).

Currently, almost 95% of the total U.S. hides (40 million annually) are exported abroad where they are processed to higher value leather which is used for car seats, garments, shoes, and other products. Proper preservation of these hides is essential during storage and transit because the hide will rapidly decay without preservation (Leach, I., and R. T. Wilson, Higher value addition through hides and skins, FAO Diversification booklet number 8, Rome, 2009; Bailey, D. G., Chapter 1, Preservation of Hides and Skins, 1998). The most common temporary preservation method utilized by the hide and leather industry is brining or salt curing. Salt works by abstracting water from the hide so that the growth of bacteria is inhibited. There are a number of advantages of salt curing, namely low cost, reliability, wide availability, ease of handling, and low toxicity when safety measures are observed (Bailey 1998; Kanagaraj, J., and N. K. Chandrababu, JALCA, 107(5): 167-174 (2001); Kanagaraj, J., et al., J. Cleaner Production, 13: 825-831 (2005)). However, the disadvantages are also significant as large quantities of salt are used (40-50% based on the raw hide weight) and processing time and high water consumption are needed to wash out salt and rehydrate the raw stock (i.e., hide). The plant effluent contains high salinity pollution load if the spent salt is not isolated. The spent salt can be highly contaminated with bacteria and therefore reusing it several times is not recommended. The disposal cost for the spent salt is quite expensive (Kanagaraj 2001 and 2005; Rao, J. R., et al., A Polymer-Based Preservation: A New Horizon in Leather Makin, Chemical Laboratory, Central leather Research Institute, Presented October 2009). Thus, because of the negative environmental impact of the high salt preservation, alternative low salt and salt-less preservation processes are urgently needed.

Previous researchers have tried several alternative salt-less or low salt preservation techniques, such as with chemicals or with radiation. The two principal radiation types used by the industry are gamma rays (photon emissions from radioactive materials) and electron beams (Bailey, G., et al., JALCA, 91: 343 (1997). High-speed electrons are used to sterilize the hides. If the hides are sterile and the enzymes in them are inactivated, non re-contaminated hides will retain the properties of fresh raw hides (Bailey 1997; Valeika, V., et al., SLTC journal, 97: 101-104 (2013)). Prior efforts at chemically improving hide preservation used boric acids (Kanagaraj 2001; Valeika 2013), benzoic and acetic acids (Kanagaraj 2001; Valeika 2013), sulfites (Kanagaraj 2005; Valeika 2013), and PEG (Rao 2009). In Zimbabwe the short term preservation of hides is based on sun drying and chilling, as well as treatment with bactericides (e.g., benzalkonium chloride, boric acid, vantocil (IB), and Busan® 30 and Busan® 52 that have been reported to yield better results in comparison with the conventional salt cured method (Kanagaraj 2005; Barret, J. C., Short term preservation of hides in Zimbabwe, J.S.L.T.C, 67: 31-40 (1983))). Research has been conducted under a memorandum of understanding between the Agricultural Research Service, U.S. Department of Agriculture, and Kalium of Canada, Ltd. to determine the effectiveness of potassium chloride (KCl, one form of potash) as a substitute for sodium chloride (NaCl) for the brine curing of cattle hides (Bailey, D. G., JALCA, 90: 13-21 (1995)). The potassium chemical can provide a necessary plant macro nutrient and the spent brine can be applied directly to the soil as a fertilizer. In fact, a large scale demonstration of raceway curing of over eighteen hundred hides showed that KCl was technically a viable alternative to NaCl (Bailey 1995) as the KCl-cured hides were found to be comparable, with only minor differences, to NaCl-cured hides for leather production. However, KCl costs more than NaCl and the use of KCl is not economically viable even considering the cost of NaCl disposal (Bailey 1995).

Thus alternative low salt and salt-less preservation processes are still urgently needed.

### SUMMARY OF THE INVENTION

Methods for preserving untanned animal hides involving contacting the hides with an aqueous suspension containing glycerol, sodium carbonate (and/or sodium bicarbonate), polyethylene glycol, and less than about 25% salt (W/W).

This summary is provided to introduce a selection of concepts in a simplified form that are further described below in the detailed description. This summary is not intended to identify key features or essential features of the claimed subject matter, nor is it intended as an aid in determining the scope of the claimed subject matter.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 shows the relative hardness of the differently cured hide samples as described below. In order to measure semi-quantitatively the hardness of each cured hide sample and to compare the texture of the control to the differently cured hide samples according to the list of conditions listed in Table 1, texture analysis was performed and the results are shown in FIG. 1.

FIG. 2 shows dehydration trend for the various curing processes and toggled on storage to dry as described below. The dehydration trend was quite similar in all curing conditions and comparable to the control.

FIG. 3 shows dehydration trend for the various curing processes and stacked on storage as described below.

FIG. 4 shows the relative final chloride content of the cured hides after 24 h brining as described below.

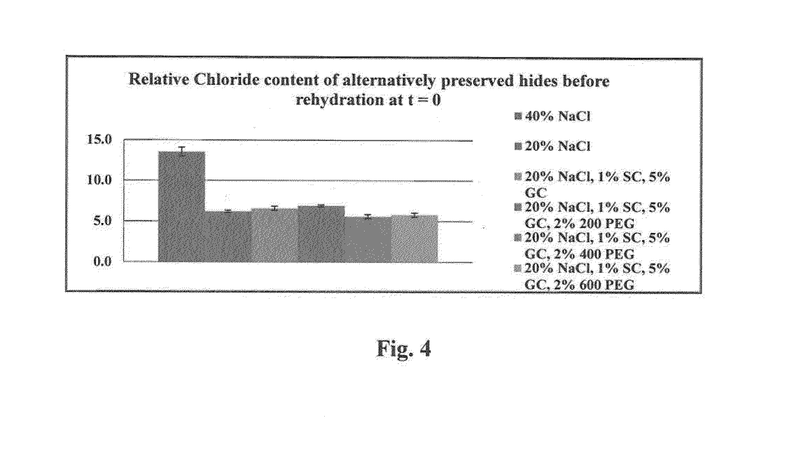

FIGS. 5A and 5B show microscopic (SEM) images of the preserved hide samples toggled while in storage/drying at 100× magnification as described below: All weights are based on the weight of raw hide sample (% W/W). (FIG. 5A) crosswise SEM view of cured hide samples. Top left is control D#1 with 40% NaCl, Top middle is D#2 (base ingredients of alternative low salt preservation also present in the other four drums: 10% NaCl+5% crude glycerol (CG)+1% sodium carbonate (SC)), top right and all bottom samples are with base ingredients contained in D#2. Top right is D#3: with 5% PEG 1.4K*, Lower left is D#4: with 5% PEG 3K*, lower middle is D#5: with 5% PEG 8K* and Lower right is D#12: with 5% PEG 8K. (*added as solid after brining with base ingredients); (FIG. 5B) Top left is test cured hide sample D#6: with PEG 200, top middle is D#7: with PEG 400, Top right is D#8: with PEG 600. Lower left is D#9: with PEG1000, middle is D#10: with PEG 1400 and lower right is D#11: with PEG 3000. All PEGs are incorporated in the low salt base brining solution found in D#2.

FIGS. 6A and B show Microscopic (SEM) images of preserved hide samples at higher 5000× magnification as described below: (FIG. 6A) Top left is half the control D#1: 20% NaCl or ˜45% salt saturation, top middle is D#2: base ingredients (10% NaCl or ˜33% salt saturation)+5% crude glycerol+1% SC) also present in D#3 to D#12, top right is D#3: with PEG 1400′, lower left is D#4: with PEG3000*, lower middle is D#5: with PEG3000 with PEG8000* and Lower right is D#12: with PEG8000*, all images at 5000× magnification, *signify that the solid PEGs were added after soaking in alternative low salt base brining solutions; (FIG. 6B) all samples contain the base ingredients composed of 10% NaCl, 5% crude glycerol and 1% sodium carbonate, top left is D#6: (with 5% PEG 200), top middle is D#7 (with 5% PEG 400), top right is D#8 (with 5% PEG 600), lower left is D#9 (with PEG 1000), middle is 1)#10 (with PEG1400) and Lower right is D#11 (with PEG3000).

FIG. 7 shows the trend of the rehydration of differently cured hides as described below.

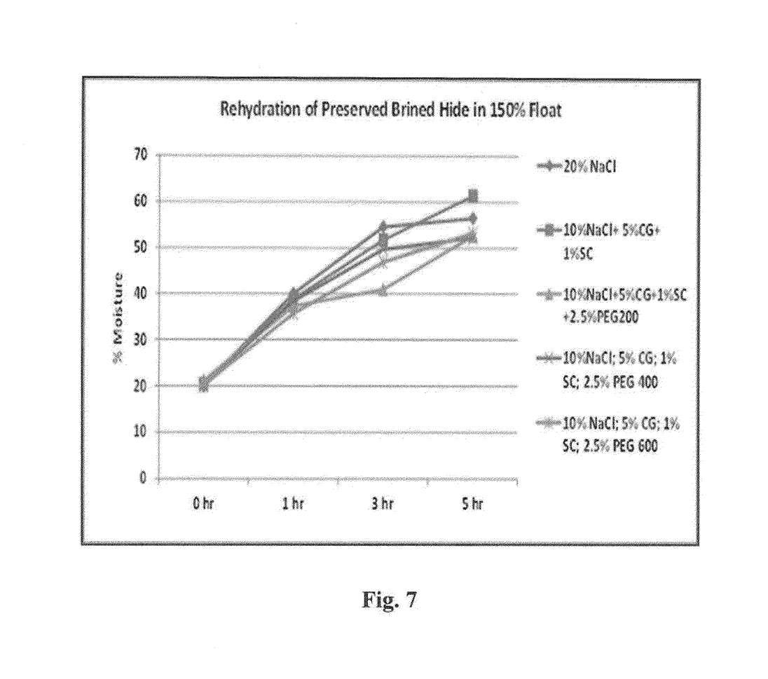

FIG. 8 shows monitoring the chloride diffusion from cured hides during rehydration prior to tanning as described below.

FIG. 9 shows relative amount of chloride in each cured hides after 4 h rehydration as described below.

FIG. 10 shows approximate chloride content of cured hides after rehydration as described below.

FIG. 11 shows microscopic (SEM) images of the crust leather products of differently preserved hides stacked while in storage/drying at 100× magnification as described below: Top left to right: 1-S (40% NaCl or 92% salt saturation control); 2-S (20% NaCl or ˜45% saturation); 3-S (20% NaCl+5% CG+1% SC), and Lower left to right: all the 3 samples contained the base ingredients in sample 3-S, 4-S (+5% PEG200), 5-S (+PEG 400) and 6-S (+PEG 600). All weights of ingredients are based on weight of the raw hide sample and triplicate trials are always performed in all experiments.

FIG. 12 shows SEM images of the crust leather products of differently cured hides toggled: Top left to right: 1-S (40% NaCl control), 2-S (20% NaCl), 3-S (the basic ingredients of the alternative brining=20% NaCl, 5% crude glycerol, 1% sodium carbonate), and Lower left to right: all samples have the base ingredients present in the 3-S sample; 4-S (+5% PEG200), 5-S (+5% PEG400) and 6-S (+5% PEG600).

### DETAILED DESCRIPTION OF THE INVENTION

Method for preserving untanned animal hides are disclosed which involve contacting the hides with an aqueous suspension containing glycerol, sodium carbonate (and/or sodium bicarbonate), polyethylene glycol, and less than about 25% salt (W/W)(preferably less than about 20% salt).

One objective of the current study was to develop an alternative brining process that requires less salt to effectively preserve bovine hides. In low salt preservation, the hardening effect due to the polyethylene glycol (PEG) polymers was compensated by adding crude glycerol (a bountiful and relatively cheap co-product of the biodiesel industry composed of ˜77% glycerol, 0.5% methanol, 0.4% other organic materials including fatty acids, and ˜22% water), and sodium carbonate. Low molecular weight PEGs were more effective than high molecular weight PEG polymers. Preservation was found to be effective because no sign of putrefaction was observed in alternatively cured hides, and the properties of these hides were comparable to those of traditionally preserved hides. By incorporating PEG along with glycerol and sodium carbonate, only a fraction of the commonly used salt was necessary for hide preservation.

One way to reduce the amount of salt needed in hide preservation is by adding PEG. In this study crude glycerol and sodium carbonate were incorporated into the brining process. The crude glycerol is a bountiful and cheap co-product of biodiesel production. In our recently concluded research project, the inclusion of crude glycerol and sodium carbonate in the presoaking solution proved to be beneficial in enhancing the efficiency of the adobe type manure removal from bovine hides. The added benefit observed was the improvement in the overall quality of finished leather derived from them. Sodium carbonate and bicarbonate have shown limited effectiveness against bacteria, particularly strains of halophilic bacteria (Kanagaraj 2001), and therefore 1% sodium carbonate has been utilized in our current study to help inhibit some bacterial growth.

PEG refers to a polymer or an oligomer of ethylene oxide and is also known as polyethylene oxide (PEO) or polyoxyethylene (POE), depending on its molecular weight. The three names are chemically synonymous, but historically PEG referred to oligomers and polymers with a molecular mass below 20,000 g/mol, PEO to polymers with a molecular mass above 20,000 g/mol, and POE to a polymer of any molecular mass (Kahovec, J., et al., Pure and Applied Chemistry, 74(10): 1921-1956 (2002)). PEG and PEO are liquids or low-melting solids, depending on their molecular weights. PEGs are prepared by polymerization of ethylene oxide and are commercially available over a wide range of molecular weights from 200 g/mol to 10,000,000 g/mol

Unless defined otherwise, all technical and scientific terms used herein have the same meaning as commonly understood by one of ordinary skill in the art to which the invention belongs. As used herein, the term “about” refers to a quantity, level, value or amount that varies by as much as 30%, preferably by as much as 20%, and more preferably by as much as 10% to a reference quantity, level, value or amount. Although any methods and materials similar or equivalent to those described herein can be used in the practice or testing of the present invention, the preferred methods and materials are now described. The following examples are intended only to further illustrate the invention and are not intended to limit the scope of the invention as defined by the claims.

### EXAMPLES

All the chemicals used for the conventional processes are of commercial grade. The chemicals used for the preparation of the different alternative brining formulations are of analytical grade. The crude glycerol was obtained from Griffin Industries (Butler, Ky.) and was used as received. Fresh hides were obtained from a local beef cattle processing plant (JBS, Souderton, Pa.). The different PEGs and sodium carbonate were obtained from Sigma-Aldrich, (St. Louis, Mo.). The bulk NaCl, TX-10, was obtained from Superior Salt LLC, (Watkins Glen, N.Y.).

Laboratory scale protocol for the alternative hide preservation: Freshly washed and defleshed hides from a local meat packing plant (JBS, Souderton, Pa.) were collected and split down the back into left and right segments. To find out which of the different molecular weights of PEG would be suitable for our purpose, small pieces of hide samples were taken. The hide was cut into 12 different groups of 2 that weighed approximately 600 g per piece (with dimension of ˜6 in×8 in) with the longer side parallel to the backbone. The basic procedure from Rao J. et al's paper (Rao 2009) was followed, with some modifications of our own by incorporating ¼ of the amount of salt traditionally used and with lower concentration of PEGs and crude glycerol as well as sodium carbonate. PEG with molecular weights of 200, 400, 600, 1000, 1400, 3000 and 8000 were chosen for the trials. PEG 200, 400 and 600 were in a liquid state, while PEG 1000, 1400 (appeared waxy solid), 3000 and 8000 were in solid state as flakes. The liquid PEGs were added to the low salt brining solution based on the weight of the raw hide (10% NaCl or 33% salt saturation, 5% crude glycerol, and 1% sodium carbonate (W/W). Then different molecular weight PEG polymers were added to 8 of the samples at 2.5%. These were PEG 200, 400, 600, 1000, 1400, 3000, and 8000 with no PEG as a control. The 1400, 3000, and 8000 PEGs were used twice: (1) as one of the ingredients in the solution and (2) the solid polymers were applied after the hides were soaked in the basic ingredients composed of 10% NaCl, 5% crude glycerol, and 1% sodium carbonate. A traditional amount of NaCl (40%) and half of that amount (20%) alone were run as the two separate controls. The hides were allowed to soak in their respective solutions in rotating/tumbling individual drums overnight at 6 rpm. The following day the differently cured hides were hung to dry and the moisture content or rate of dehydration was monitored. To compare the relative hardness of the resulting cured hides, texture analysis was performed on dried hide samples using a CT3-texture analyzer (CT3-Texture Analyzer Manual, Brookfield Engineering, Inc, Middleboro, Mass., 2009). The amount of work needed to attain the same deformation at certain predetermined peak loads on the cured dry hide at certain depth and the ratio of total work done to total hardness was calculated for each sample (Aldema-Ramos, M. L., et al., JALCA, 107(5): 167-174 (2012); CT3—Texture Analyzer Manual).

Texture Analysis of the cured hides: A texture analysis was performed using a texture pro program (CT3—Texture Analyzer Manual, Brookfield Engineering, Inc, Middleboro, Mass., 2009). Using the TA10 probe at a 20 g load for 5-7 mm of penetration, the hardness, hardness work cycle, adhesiveness, total work, load at target, and deformation at target were determined. These data points were taken three times at different locations on the sample to improve homogeneity of the results. The samples that had comparable hardness or were softer than the control were selected for further trials. Using this information the decision was made to go forward with five conditions in the next trial out of the previously tested two dozen conditions. The control was once again 20% and 40% NaCl (W/W). The other four alternative low salt brining solutions each contained 20% NaCl, 5% crude glycerol, and 1% sodium carbonate. The three test hide samples had 2% of PEG 200, PEG 400, and PEG 600, respectively, as tabulated in table 2. One group of trials was stacked and the other similarly treated trials were toggled during storage.

Chloride content determination: Chloride content determination was performed by taking the hide samples out of the mini drums to cut a representative sample size at a certain time while the brining was taking place. The sample piece was weighed out (˜2 g), soaked in 25 ml of deionized (DI) water, and the chloride was extracted by stirring constantly at about 100 rpm for 30 min. Then 0.5 ml of 0.5M potassium dichromate was added as indicator, and the solution was titrated with 0.1N silver nitrate to reddish end point (following the Mohr method; Pierce, W. C., et al., “Quantitative Analysis”, 4th Ed., John Wiley & Sons, pp 328-9 (1958)). When the color changed from yellow to orange the amount of silver nitrate used was recorded. The percent by weight of NaCl in each sample was calculated. Triplicate trials were run for each sample to improve accuracy.

Scanning electron microscopy: From the preserved hide samples ˜1.5 mm pieces were cut and mounted on stubs and sputter-coated with thin layer of gold using a Scancoat Six Sputter Coater (Edwards Scancoat 6, West Sussex, UK) for 90 seconds in two orientations. The samples were then observed with FEI Quanta 200 FEG Environmental Scanning Electron Microscope (SEM) (Hillsboro, Oreg.) in high vacuum-secondary electron imaging mode with an accelerating voltage of 10 KV. Digital images were collected at 100, 500, 1000, 5000 and 10000× magnifications.

Moisture and ash content determination: The percentage of moisture and ash were determined by applying the American Standard Testing Method International D7476-08 (ASTM D7476-08 Standard test Method for BSV of salt-preserved hides and skins, JALCA, p. 143 (1963)). About 2 g of samples were taken from each treated hide to be used for percent moisture and ash testing in triplicate trials. This was done by weighing the samples in a crucible and then placing them in a vacuum oven for 3 h at 60° C. and 100° C. overnight. The percent moisture was calculated from the weights of the sample obtained the following day after equilibration at ambient temperature and pressure. The dried samples were placed in a furnace for 1 h at 100° C. and then at 600° C. overnight (ASTM D7476-08; Roddy, W. M. T., Moisture and Ash Analysis of Skin, Hide and Leather, The Chemistry and Technology of Leather, Vol. IV, p. 3, O'Flaherty, Roddy and Lollar editors, Reinhold Publishing Co., NY, 1965). The percentage (%) ash was calculated from the weights of the ash of the samples compared to their original weights.

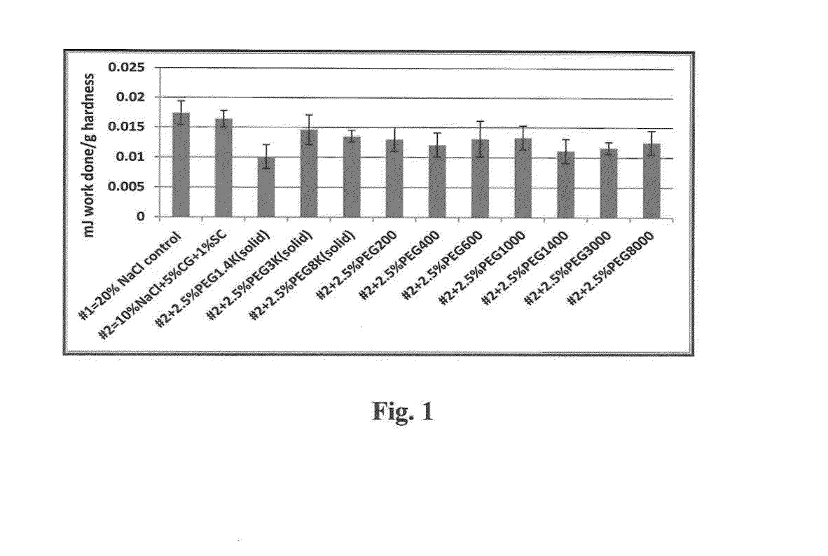

Results and Discussion: In order to optimize the level of PEG to be used, an initial set of trials was performed by utilizing small hide pieces (˜600 g each). The drying process was relatively fast at ambient temperature and pressure because of the small size of the hide samples used. All the preserved hide samples appeared similarly cured having dried up and having no bad smell, nor was hair slip apparent. The absence of too much moisture in the hide inhibited microbial growth that could have led to hide damage through putrefaction. After allowing the cured hide pieces to dry, the samples were hard and rigid to the touch. The hides cured with PEGs were harder to the touch than the control hides. In order to measure semi-quantitatively the hardness of each cured hide samples and to compare the texture of the control to the differently cured hide samples according to the list of conditions listed in Table 1, texture analysis was performed and the results are shown in FIG. 1.

The hardness of each sample was obtained by calculating the Total Work Done to cause the same preset deformation on each hide sample (Aldema-Ramos 2012; French, Alister C., et al., “High Purity Discrete PEG Oligomer Crystals Allow Structural Insight”, Angewandte Chemie International Edition, 48 (7): 1248-1252 (2009)). The harder or tougher is the sample underneath the grain layer, the higher is the total work needed in mJ per g average Load at Target or its hardness. In the current situation, we considered taking and calculating the work needed to cause the same deformation of 5-7 mm into the preserved dried hide samples. Overall the alternatively preserved hides were surprisingly softer than the control samples (traditionally cured hides with 40% NaCl) because the total work done per gram hardness of the samples were relatively lower.

Among the PEGs of different molecular weights, three PEGs (200, 400 and 600 molecular weights) were chosen to pursue further experimentations as given in Table 2. Additional data were gathered such as the moisture and ash content as well as the brine saturation values (BSV; ASTM D7476-08; Roddy 1965) of the cured hides as tabulated in Table 3.

The dehydration was monitored by taking a piece of the samples and analyzing the moisture content at the end of the designated time from 0 to 168 h. The critical moisture content where the microorganisms would not thrive was attained at around 96 h when the moisture content was lower than 50%. The control showed ˜40% moisture, whereas the alternatively cured hides surprisingly showed much lower moisture values in the range of 20-25% moisture. It was observed that the alternative curing, with low salt in the presence of PEG, had surprisingly enhanced the efficient removal of moisture.

The principle of the dehydration of water below the 50% moisture level was adopted in the curing process (Bailey 1998; CSIRO paper: Curing Hides and Skins: General Requirements, 2012). The moisture content present in raw hide sample was found to be ˜70%. After 24 h curing with 20% NaCl (W/W) as the control of the low salt brining in Table 3-A, the moisture content came down to ˜64% which was still above the critical amount of 50% and thus microbial growth would not be inhibited. With crude glycerol and sodium carbonate the moisture content went down to ˜56%. When PEGs were included, the average moisture content was surprisingly brought down to ˜51-55% similar to the 40% salt cured hide control sample with ˜54% moisture. After three weeks of storage at ambient conditions, the moisture content surprisingly went down much lower than the critical moisture content, implying that microbial growth was inhibited which resulted in the absence of bad smell or hair slip similar to the control cured hide.

Chloride content determination: To evaluate whether sufficient salt had been retained by the cured hides, the percentage brine saturation value (% BSV) was obtained; the ratio of ash to moisture was multiplied by 100 then divided by 35.9 which is the percent salt to moisture ratio in a saturated NaCl (brine) solution (ASTM 17476-08; Roddy1965): % BSV=(ash/moisture×100)/35.9

At 20% NaCl (W/W) and with the base ingredients of 5% crude glycerol+1% sodium carbonate, the BSV value was almost within the range of 40-43±1.5% with and without PEG. The ash to moisture ratio values were also closely related, suggesting that the additives, such as PEG, crude glycerol and sodium carbonate, did not contribute to any additional ash content.

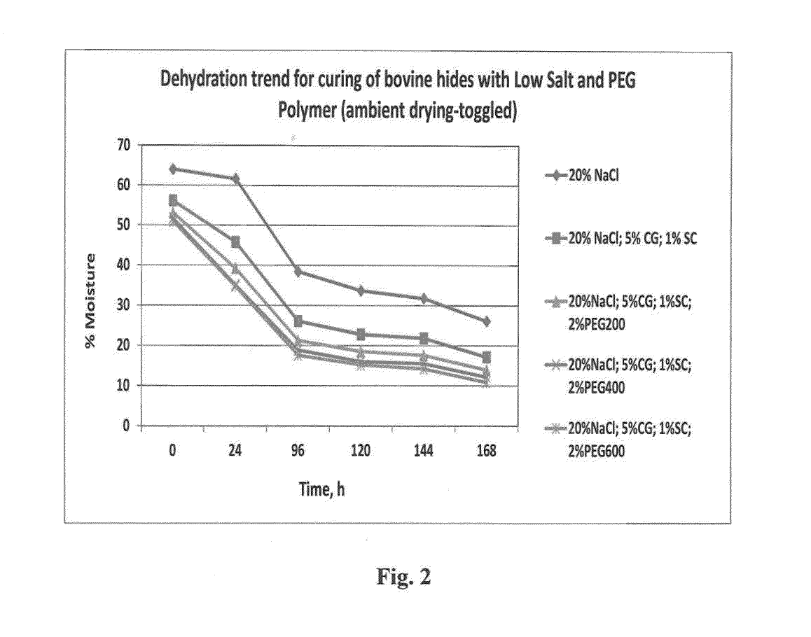

The dehydration trend was quite similar in all curing conditions as seen in FIG. 2. The initial moisture content of the raw hide was about 55-65%. NaCl alone had more initial water content (˜65%) and at the end it also had the highest final concentration of ˜25%. The test solutions that initially had an average of 55% moisture surprisingly had about 15% moisture at the end of the experiment (after 168 h). Because the hide pieces used for the experiment were relatively small, the moisture content of the cured hides had already gone down much lower than the critical moisture level after ˜96 h, a sign of good preservation.

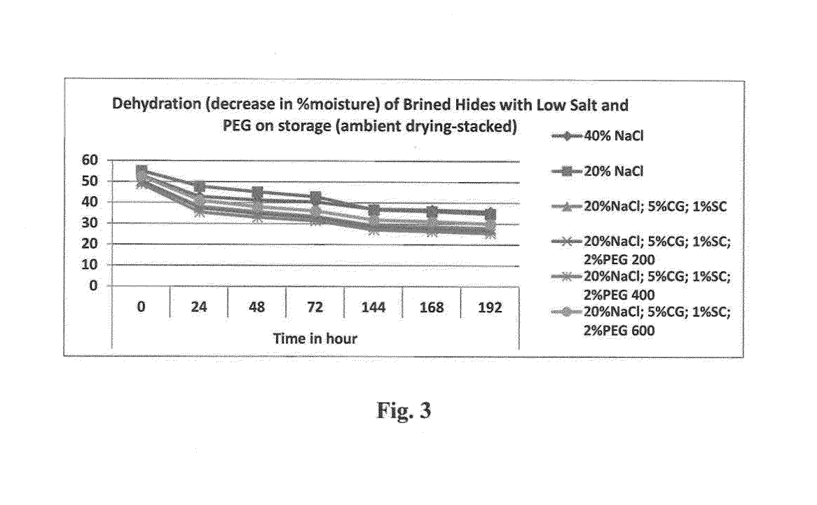

The dehydration trends in FIG. 3 were slower than in FIG. 2 and also behaved quite similarly in all curing conditions. The initial moisture content of the raw hides was about 50-60%. Both control cured hides with 40% NaCl (W/V) and 20% NaCl (W/V) alone ended with about 35% moisture. Whereas the alternatively cured hides with low salt (20% NaCl), with and without PEG, but with base ingredients composed of crude glycerol and sodium carbonate, surprisingly ended with similar moisture contents of ˜30% from 144 h to 192 h. When samples were toggled, and more area was exposed to dry in air, the final moisture contents after 168 h were relatively lower (˜15%, FIG. 3A) compared to stacked cured hides that ended with higher values (˜30%) as seen in FIG. 3B. Samples used for the results illustrated in FIG. 3B were relatively larger (1000 g) than those used in FIG. 3A (˜600 g). In both cases the moisture content of the cured hides had already gone down much lower than the critical moisture level after ˜120 h, a sign of good preservation.

Shrinkage temperature is a measure of the hydrothermal stability of the leather samples. The shrinkage temperature of the test leather samples were observed to fall within the range of 81 to 84±2° C.) of the control leather (at ˜83° C.). It implies that the integrity of the hide grain was not compromised nor adversely affected by PEG and crude glycerol, and that the method of less salt preservation is quite promising.

In the control hide cured with 40% NaCl (W/W), the chloride content was about 13-14% based on the 30 min extraction of chloride from hide pieces of similar weights (˜2 g) with deionized (DI) water. The alternatively cured hides with 20% NaCl (W/W), with and without PEG, contained about 6-7% chloride or half the amount of NaCl absorbed by the control.

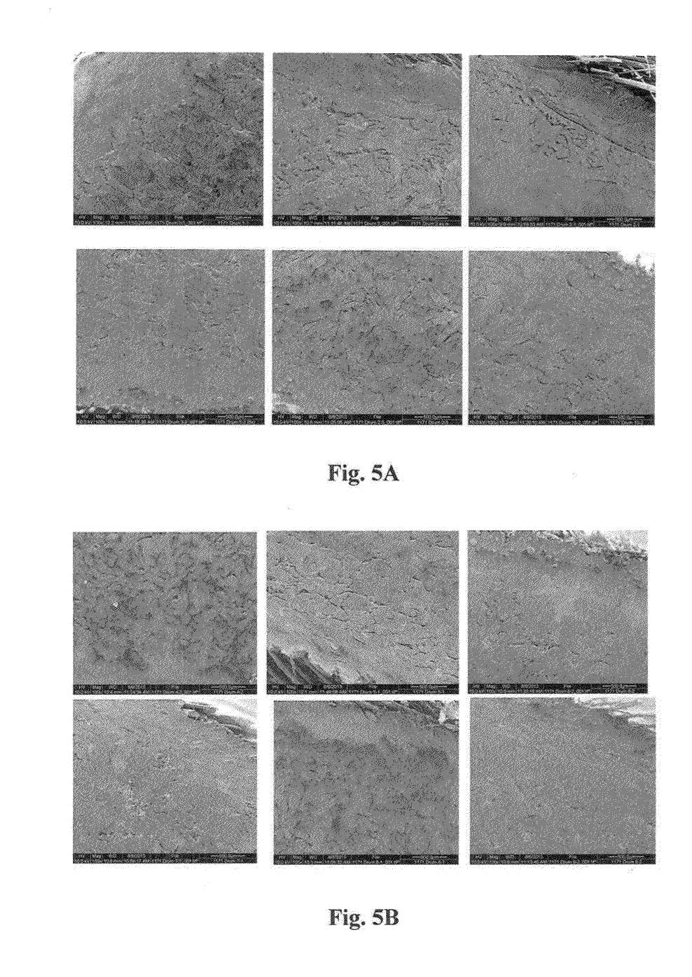

Scanning Electron Microscopy of cured hide samples: Microscopic (SEM) images can demonstrate any changes in the fibrillar structure of the cured hides. All the images in FIGS. 5A and 5B, the control (D#1) and with PEGs (D#2 to D#12), were closely related and appeared to be a mixture of sticky and loose regions.

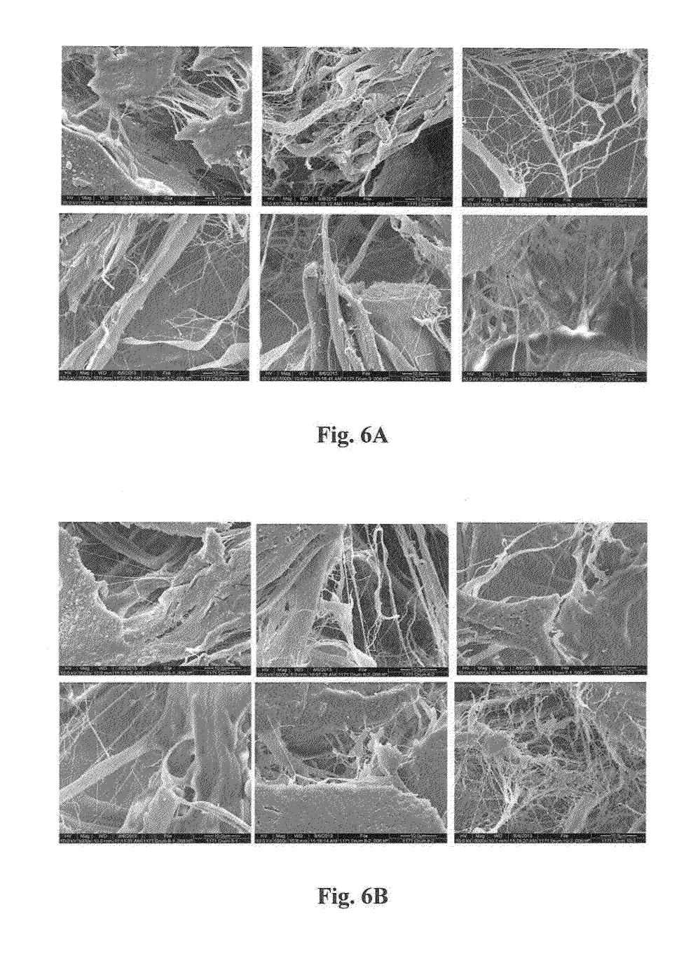

The preserved hides treated with PEG 200 (D#6) and PEG 400 (D#7) surprisingly showed a relatively more open interfibrillar structure in its SEM microscopic level images (FIGS. 6A and 6B). This was good news because normally, when the water content of hides go lower than 15%, the interfibrillary proteins remain intact and rehydration can usually take longer because the fibers stick together (Kanagaraj 2001; CSIRO paper: Curing Hides and Skins: General Requirements, 2012); however, it was surprisingly not the case here. In fact, looking more closely at a much higher magnification images as shown in FIGS. 6A and 6B, the combination of loose and intact fibrillar network or arrangements were similarly exhibited in all samples and were comparable to the control.

Table 6 refers to the large scale curing trials where the samples taken from the same region but from 2 different hides are compared after subjecting to the same curing conditions. To verify if the applicability of the formulations are repeatable. The samples were also placed in a humidity and temperature controlled chamber to mimic the probable condition of the cured hides while in transit during shipment in cargo ships.

In any curing process, pH is one of the important factors to be considered. Most bacteria are active at neutral pH or slightly basic conditions. At around pH 7.5, the hydrolysis of collagen by proteolytic bacteria was shown to be maximum (Kanagaraj and Chandrababu, JALCA (2001). At pH ˜9.0 the activity is weaker and at pH range between 5.5 and 6.6, the bacterial activity is negligible. The two promising formulations in drums #5 and #6 have pH of 9.6+0.1, implying a weaker bacterial activity, thus inhibiting its growth. Whereas the control in drums #1 and #2 have pH values of 6.85+0.05, close to neutral that could allow bacterial growth with lower inhibition. Another important factor is TDS (total dissolved solids) which is a measure of the pollution load the process could discharge into the environment. Surprisingly, the promising formulation in Drums #5 and #6 had about 55% less (31.5+0.5 ppt) polluting ability than the control (70±1 ppt). Despite the fact that four other ingredients were added to the low salt brining solution in drums #5 and #6, the pH values were surprisingly still quite favorable to the inhibition of bacterial growth and lower pollution load and so can be conclusively claimed environmentally friendly process. COD (chemical oxygen demand) analysis measures the organics in wastewater or effluents and can be used indirectly as a measure of pollution it can introduce into the environment. Determinations were performed photometrically (colorimetrically) with Hach® Method 8000 similar to EPA Method 410.4. The COD results showed that the alternatively cured hides generated about 30% more organic carbon. However, the total dissolved solids or TDS surprisingly was actually less than 50% compared to the control.

Conclusions: Surprisingly, by incorporating PEG, only a fraction of the commonly used amounts of salt (˜90% to ˜30% salt saturation) was necessary to generate an efficiently preserved hide. The presence of glycerol counteracted the tendency for over drying caused by PEG that ameliorated the negative effects brought by drying such as a tighter or more intact interfibrillar structure that would require a longer rehydration period before it is possible to tan the hides to leather. Instead, the low salt curing was surprisingly as efficient as the high salt control in hide preservation and yet the hide was softer. Rehydration before tanning should take a shorter time because the amount of chloride is already relatively lower in the newly developed low salt preservation process. The ash to moisture ratio values were also closely related, suggesting that the additives, such as PEG, crude glycerol and sodium carbonate, surprisingly did not contribute to any additional ash content or its total dissolved solids. As discussed below, we then pursued the promising low molecular weight PEGs in larger scale hide preservation studies and finished the cured hides to crust leather and verified its quality by measuring its mechanical properties. The promising alternative low salt preservation had surprisingly shown several ideal characteristics that the hide industry would most likely implement it in their facilities. The pH at ˜9.5 is desirable for inhibition of unwanted bacterial growth. The wastewater has less than half the amount of pollution load in terms of TDS, it can introduce into the environment compared to the control. The overall mechanical properties of the leather produced from the hide cured with low salt in the presence of PEG, crude glycerol, potassium nitrate and sodium carbonate have improved across the board.

Laboratory Scale Protocol for the alternative hide preservation: A traditional amount of NaCl (40% W/W) and half of the amount (20% W/W) alone were run as the two separate salt preservation controls. The hides were allowed to soak in their respective solutions in individual rotating drums overnight at 6 rpm. The following day, the differently cured hides were hung to dry (toggled) for a week. In another batch, the cured hides were stacked as the custom in industry. The other trials either contained the basic ingredients (composed of 20% NaCl, 5% crude glycerol, and 1% sodium carbonate) or contained these materials plus 2-4% PEG 200, PEG 400 or PEG 600, as listed in Table 4.

Rehydration of cured hide samples: The control and alternatively cured bovine hide samples were stored for two weeks and rehydrated in 150% float of water and biocide (0.15% Boron TS and 0.10% Proxel®) based on recorded dry weight in Dosemat mini drums for 18 hours at 6 rpm. During the first 6 hours of the rehydration study, aliquots from the float solution were extracted and a hide sample was cut at each hour to determine the concentration of sodium chloride suspended in the float and brined hide sample. The next day, the hides were transferred to a canbar drum for the dehairing process. Triplicate trials were performed for each curing condition.

Tanning of cured hides: The protocol followed was the standard USDA/ARS/ERRC tanning process for brined hides as follows. The cured hide was dehaired in a 200% float composed of 4% sodium sulfide, 4% lime, and 2% soda ash. This was run at 6 rpm for 10 min/hr for 4 hrs. Then the hide was washed with 100% float for 5 min at 6 rpm. The hair was cleanly removed and the hide appeared quite slippery. The liming process was started by adding a 200% float with 2% lime and 1% sodium sulfide run at 6 rpm for 3 min/hr overnight.

Another whole hide sample was obtained from JBS (Souderton, Pa.) for another batch of trials. This time it was cut into six pieces at approximately 1000 g each, 12 inches by 14 inches in dimension. The solutions used in this trial were the same as those from the previous trial, with the addition of a 40% NaCl control. They were soaked in individual rotating drums in their respective solutions at 6 rpm overnight. Again, samples were taken before drying to prevent hardness from affecting sample preparations. This time, however, the hides were folded and stacked to dry (instead of being hung or toggled), similar to what is done in the industrial practice. The preserved hides were soaked to remove excess salt and to determine the rehydration rate. The standard tanning procedure for brined hides was also followed.

Scanning Electron Microscopy: The crust leather samples were cut to ˜1.5 mm pieces and mounted on stubs and sputter-coated with thin layer of gold using a Scancoat Six Sputter Coater (Edwards Scancoat 6, West Sussex, UK) for 90 seconds in two orientations. The samples were then observed with FEI Quanta 200 FEG Environmental Scanning Electron Microscope (SEM) (Hillsboro, Oreg.) in high vacuum-secondary electron imaging mode with an accelerating voltage of 10 KV. Digital images were collected at 100, 500, 1000, 5000 and 10000× magnification.

Mechanical properties of the crust leather product: From the crust leather samples, five dog bone samples were cut for mechanical property testing as described in ASTM D2813-03 (ASTM D2813, Standard practice for sampling leather for physical and chemical tests, ASTM International, 15(04): 266-267 (2007)) with the long dimension parallel and short dimension perpendicular to the backbone. They were allowed to sit out and equilibrate in a humidified room overnight before testing. The mechanical property measurements included tensile strength, elongation-to-break (“stretchability”), Young's modulus (“stiffness”), and fracture energy (the energy needed to fracture leather samples, its “toughness”). The average thickness of the leather samples varied from 1.7 mm to-2.7 mm. An upgraded Instron mechanical property tester, model 1122 (Instron, Norwood, Mass.), and Testworks 4 data acquisition software (MTS Systems Corp., Minneapolis, Minn.), were used throughout this work. The strain rate was set to 25.4 cm/min with a grip distance of 5 cm. Each test was conducted on five samples to obtain an average value.

Hydrothermal Stability (Shrinkage temperature): The test procedure followed was as described by Fein et al. (Fein, M. L., et al., JALCA 60(1): 15-30 (1965); Taylor, M. M., et al., JALCA, 104(4): 79-91 (2009)). Two strips with a dimension of 7/32×2¼ inch (5.6×57.2 mm) piece of each of the leather samples were cut using a specialty die. They were then allowed to soak in deionized (DI) water overnight. The following day, the leather strips were degassed by suction for about ten minutes with three minute intervals releasing the vacuum. The beaker with water and leather strips were manually swirled for more efficient removal of air bubbles trapped in the sample. The strips were then clamped and hung along the side of the tall beaker with about 800 ml water equipped with a stir bar and thermometer on a hot plate. The stir bar was then set to spin slightly and the temperature was adjusted to about 150° C. The temperature was allowed to raise at ˜2° C./min, and it was watched closely for any signs of shrinkage such as curling of the leather sample after the temperature reached ˜70° C. The water bath was replenished to bring the starting temperature down to less than 40° C. before another sample was assembled and tested. The same steps were repeated for all the other leather samples tested. The shrinkage temperature were then recorded and tabulated.

Results and Discussion. Rehydration of the cured hides: Before tanning the previously preserved hides, the first step was to remove the excess salt. At the same time, the relatively dried and hardened hide had to be rehydrated and softened prior to brining so that the tanning chemicals can be used effectively.

The starting water content in each of the five well preserved and relatively dried hide samples was almost the same at ˜20% moisture. This was much lower than the critical moisture content where microorganisms can grow and thrive (>50%), thus the curing was surprisingly quite effective in all the tested conditions because microbial growth was inhibited.

The rate of rehydration using just the base ingredients which were present in all the test solutions, composed of 10% NaCl+5% crude glycerol and 1% sodium carbonate, was surprisingly similar to that obtained with 20% NaCl alone. When using the alternative preserving solutions with PEG 200, PEG 400 and PEG 600, a relatively stable moisture content of about 50% was surprisingly reached after 3 h soaking. After 5 h the moisture content surprisingly increased to almost 60%, close to the ˜70% moisture in raw hides. Potentially, a lower amount of water can be used during rehydration and soaking prior to tanning the hides to leather because the amount of salt included in low salt brine curing was already quite low. Thus the amount of waste water discharged into the environment could also be lowered considerably.

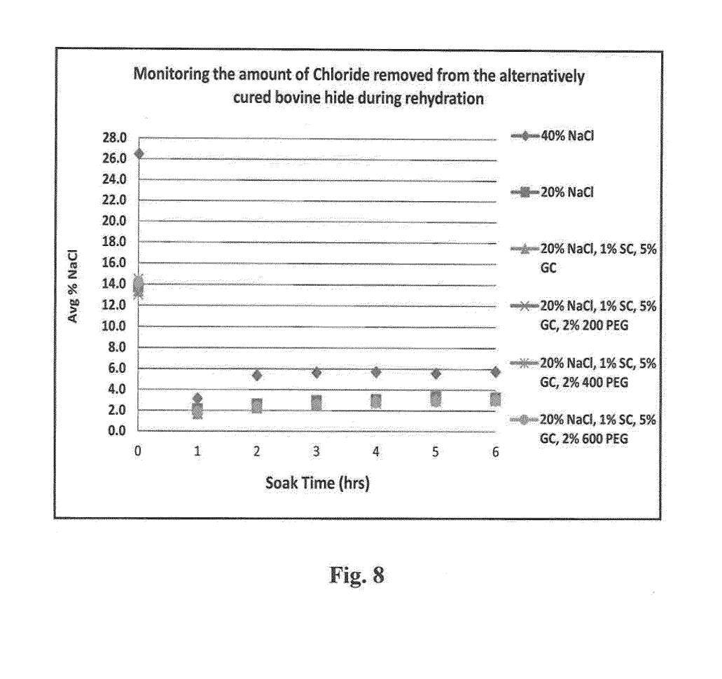

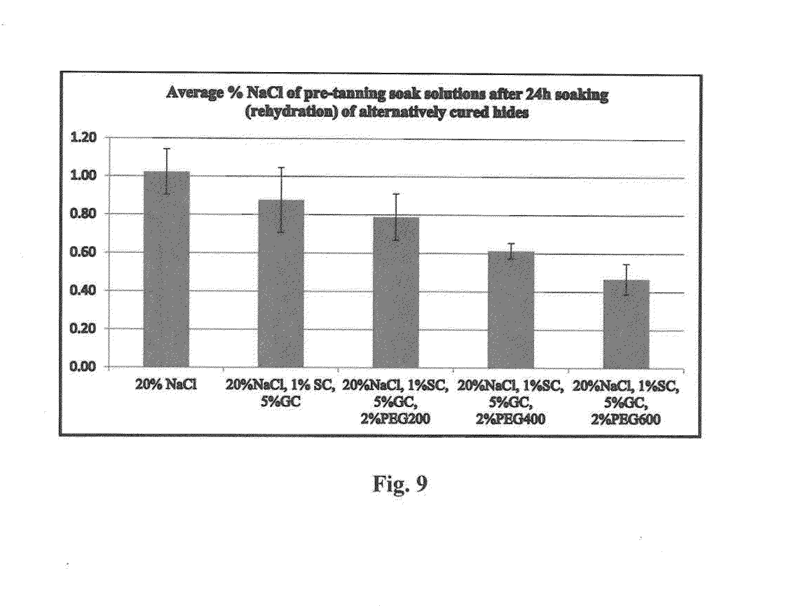

Periodically, from 0 to 6 h, an aliquot of the brining (soaking) solution or float were analyzed for chloride content to monitor the rate of diffusion of salt from the hide. Salt concentrations were determined by the Mohr method. From FIG. 8, the control hide cured with 40% NaCl had 26% NaCl whereas the rest of the alternatively cured hides with 20% NaCl with and without PEG were surprisingly found to be ˜14% NaCl. The trends in the salt diffusion out of the cured hides were similar at every hour each aliquot were taken. The values were consistently half that of the control. The amount of chloride diffusing out of the cured hides hit a plateau after 3 h soaking where ˜6% NaCl was found for the control and ˜3% NaCl was found for the remainder of the tested hides. The trend can be clearly seen in FIG. 9.

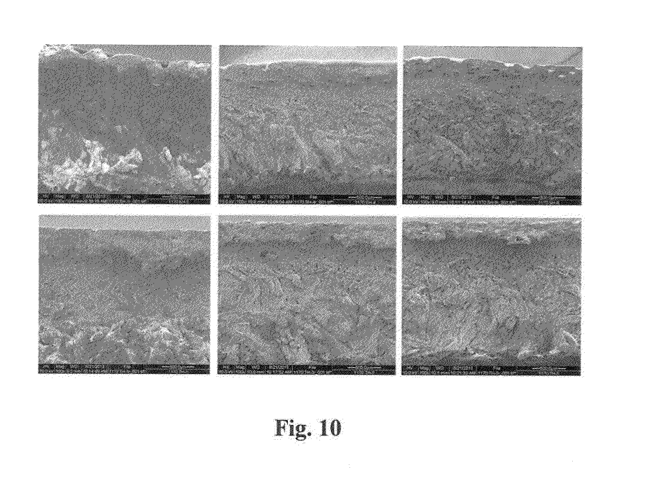

In the standard USDA tanning procedure for brined hides, 4 h rehydration was suggested. The relative amount of chloride left in the preserved hides after removing any excess sodium chloride and immediately before tanning the soaked hides are shown in FIG. 9. The control hide preserved with 40% (W/V) NaCl had about 6% NaCl, whereas the alternatively preserved hides with 20% NaCl, with and without PEG, exhibited similar results with ˜3% NaCl left on the hide before tanning to leather. This suggested that it would take a shorter rehydration time, and also that a lower amount of water would be required to remove excess NaCl. If the rehydration was allowed to go for 24 h, the amount of available NaCl left in the preserved hides were almost negligible, surprisingly ranging from 0.5%-0.8% in the alternatively preserved hides compared to ˜1% in the control, 20% (W/V) NaCl, as shown in FIG. 10.

Hydrothermal stability of the resulting leather samples: Shrinkage temperature is a measure of the hydrothermal stability of the leather products in two separate batches. The results are tabulated in Table 5. The shrinkage temperature of the test leather samples was surprisingly observed to fall within the range of 81 to 84±2° C. of the control leather made from traditionally salt preserved hides (at ˜83° C.) which implies that the integrity of the hide grain was surprisingly not compromised nor adversely affected by PEG and crude glycerol, and that the method of less salt preservation is quite promising.

The overall mechanical properties of the resulting leather products from the low salt conditions were surprisingly either similar or better than those from the control. For example, the treatment composed of 20% NaCl in the presence of 5% crude glycerol and 1% sodium carbonate with PEG 200 compared to the control cured with 40% NaCl: tensile strength (10.3±1.7 vs. 9.8±1.2 MPa), elongation-to-break (63.5±1.7 vs. 59.7±5.4%), Young's modulus (8.8±1.2 vs. 10.6±1.3 MPa), fracture energy (2.09±0.49 vs. 1.99±0.34 J/cm³), and toughness index (1.29±0.22 vs. 0.95±0.18). The treated leather samples were surprisingly relatively tougher, more stretchable and softer than the control. These are the properties of leather products that are considered of good quality.

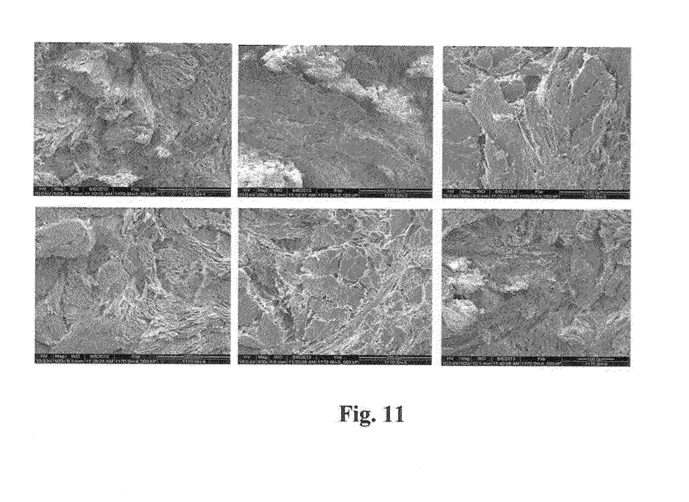

Scanning Electron Microscopy of crust leather: Scanning Electron Microscopy images at different magnifications were taken to compare the microscopic interfibrillary structure of the finished crust leather from alternatively preserved hide samples compared to the control. There was surprisingly no significant difference in terms of the collagen fibers structure in alternatively preserved hides compared to the control SH-1 with 40% NaCl brining solution. However, the grain portions of the hides did exhibit some visible differences. The control hide preserved with 40% NaCl as the top left image in FIG. 10 showed much rougher edges along the grain upper side compared to the test preserved hides that surprisingly had smoother surfaces both in the stacked (FIG. 11) and in the toggled samples (data not shown).

There was surprisingly no significant difference in terms of the collagen fibers structure in alternatively cured hides compared to the control 1-S. The closest in terms of the collagen fiber structures to the control was the test sample 4-S (20% NaCl, 5% crude glycerol, 1% sodium carbonate+2% PEG 200) (images top left and bottom left) in FIGS. 5A and B. Test sample 3-S (with the base ingredients composed of 5% crude glycerol, 1% sodium carbonate) and test sample 6-S (also with the base ingredients but in the presence of PEG 600) appeared to have the same tighter inter fibrillar structure as the control. The results were quite promising because the fibrillar structures surprisingly did not undergo unwanted abrupt changes during rehydration and behaved similarly to the traditionally preserved hides when tanned to leather.

Pollution load based on TDS, total dissolved solids, and pH values of Wastewater effluents from the 6 large scale trials listed in Table 6 after 24 h curing and 24 h rehydration before tanning to leather. It shows how relatively lower the TDS of the test hides compared to the control despite the addition of other ingredients such as crude glycerol, sodium carbonate and PEG.

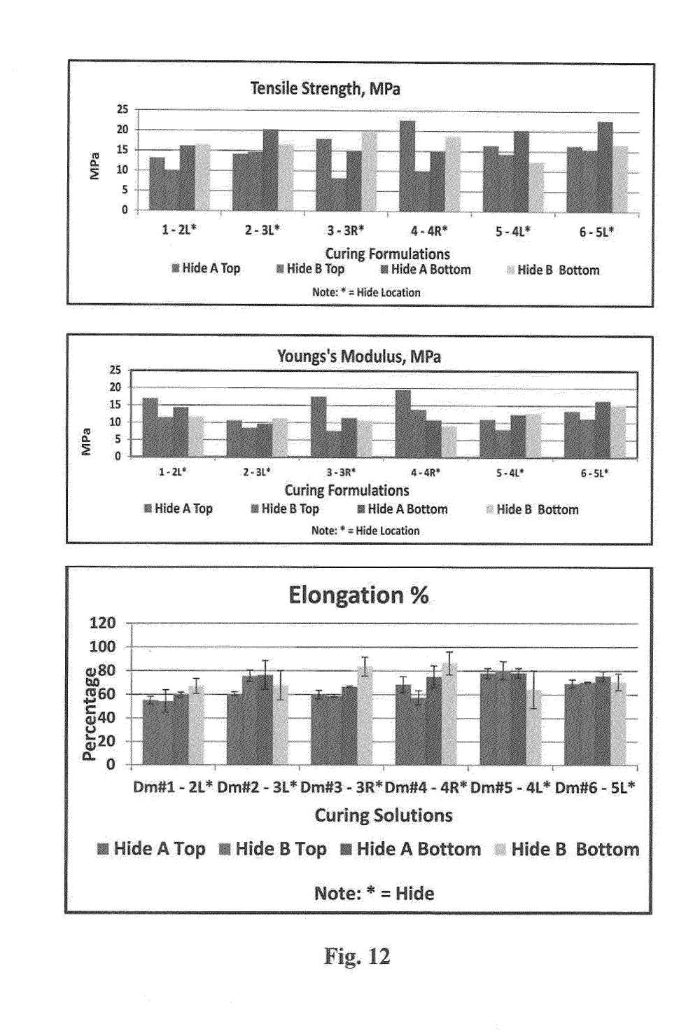

Mechanical properties of the finished leather from the large scale conditions listed in Table 6 are shown in FIG. 12. Leather samples made from Drums #5 and #6 were consistently better than the control and the formulations without crude glycerol and sodium carbonate from Drums #3 and #4.

The Cost assessment in Table 8 show that the low salt alternative hide preservation processes (Drums #5 and #6) cost about 30% less than Drum #1, the control. All the more it is promising and desirable. In addition to lower cost of implementation, it is environmentally friendly and has lower pollution load than the control. The overall quality of the crust leather are also improved.

Conclusion: The rehydration rate of the alternatively cured hides with PEG 200, PEG 400 and PEG 600 surprisingly reached a stable moisture content similar to that of the original raw hide (between 60-70%) within 3-4 h, similar to the control. Potentially, less water could be used during rehydration and soaking prior to tanning the hides to leather because the starting amount of salt included in the low salt brining solutions was already quite low. Therefore the amount of waste water discharged into the environment could be considerably reduced as shown in less than 50% total dissolved solids results obtained. So far the resulting crust leather products surprisingly did not show any holes or signs of degradation of the collagen fibers due to putrefaction when quick and unwanted drying of the cured hides took place. The presence of PEG and glycerol surprisingly helped in the controlled drying process of the preserved hides and surprisingly the resulting leather was stronger, more stretchable and softer than the control. PEG, in the presence of crude glycerol and sodium carbonate, were surprisingly quite desirable as ingredients in the new alternative less-salt and environmentally friendly hide preservation process. The alternative low salt preservation has lower pollution load, requiring less water during rehydration because the chloride content is already quite low. Furthermore, the cost assessment demonstrated that the implementation would cost less than the control.

All of the references cited herein, including U.S. patents, are incorporated by reference in their entirety. Also incorporated by reference in their entirety are the following U.S. Pat. Nos. 3,986,926; 4,164,393; 4,713,078; 5,096,553; 6,086,633; 6,092,301.

Thus, in view of the above, there is described (in part) the following:

A method for preserving untanned animal hides comprising (or consisting essentially of or consisting of) contacting (treating) the hides (for about 8 to about 24 hours) with an aqueous suspension containing glycerol, sodium carbonate or sodium bicarbonate, polyethylene glycol, and less than about 25% (or less than about 20% or less than about 20% or about 16%) salt (W/W) (about ⅕ of the traditional curing (˜80/5=16% based on W/W of raw hide weight or 8% in 200% float). The above method, wherein said contacting is for at least about 8 hours. The above method, wherein said contacting is for no more than about 24 hours. The above method, wherein said composition contains no more than about 10% (or no more than about 10% or no more than about 5% or about 2%) glycerol. The above method, wherein said composition contains no more than about 5% (or no more than about 2% or no more than about 1% or about 0.5% W/V) sodium carbonate or sodium bicarbonate. The above method, wherein said composition contains no more than about 10% (or no more than about 5% or about 2%) polyethylene glycol. The above method, wherein said polyethylene glycol has a molecular weight of 600 or less. The above method, wherein said polyethylene glycol has a molecular weight of 400 or less. The above method, wherein said polyethylene glycol has a molecular weight of 3000 or less. The above method, wherein said glycerol is crude glycerol. An aqueous suspension comprising (or consisting essentially of or consisting of) glycerol, sodium carbonate or sodium bicarbonate, polyethylene glycol, and less than about 25% salt (W/W).

Other embodiments of the invention will be apparent to those skilled in the art from a consideration of this specification or practice of the invention disclosed herein. It is intended that the specification and examples be considered as exemplary only, with the true scope and spirit of the invention being indicated by the following claims.

TABLE 1
List of different alternative curing solutions and the corresponding
ingredients with high to low molecular weight PEGs.

| Sample code | Curing solution ingredients |
|---|---|
| D#1 = control | 20% NaCl |
| D#2 = base ingrdnts | 10% NaCl + 5% Crude Glyc (CG) + 1% Sodium |
| | carbonate (SC) |
| D#3 | 10% NaCl + 5% CG + 1% SC + 2.5% PEG |
| | 1400* (added solid) |
| D#4 | 10% NaCl + 5% CG + 1% SC + 2.5% PEG |
| | 3K* (added solid) |
| D#5 | 10% NaCl + 5% CG + 1% SC + 2.5% PEG |
| | 8K* (added solid) |
| D#6 | 10% NaCl + 5% CG + 1% SC + 2.5% PEG 200 |
| D#7 | 10% NaCl + 5% CG + 1% SC + 2.5% PEG 400 |
| D#8 | 10% NaCl + 5% CG + 1% SC + 2.5% PEG 600 |
| D#9 | 10% NaCl + 5% CG + 1% SC + 2.5% PEG 1000 |
| D#10 | 10% NaCl + 5% CG + 1% SC + 2.5% PEG 1400 |
| D#11 | 10% NaCl + 5% CG + 1% SC + 2.5% PEG 3000 |
| D#12 | 10% NaCl + 5% CG + 1% SC + 2.5% PEG 8000 |

TABLE 2
The list of the different curing conditions tried where, T = toggled
and S = stacked, are the 2 ways of storing or drying the cured hides.
The three test hide samples had 2% of PEG 200 (4-S), PEG 400 (5-S),
and PEG 600 (6-S), respectively, as tabulated in table 4.

| Drum | |
|---|---|
| | Curing Solution Ingredients, stacked |
| 1-S | 40% NaCl |
| 2-S | 20% NaCl |
| 3-S | 20% NaCl + 5% Crude Glycerol + 1% Sodium Carbonate |
| 4-S | 20% NaCl + 5% Crude Glycerol + 1% Sodium Carbonate + 2% |
| | PEG 200 |
| 5-S | 20% NaCl + 5% Crude Glycerol + 1% Sodium Carbonate + 2% |
| | PEG 400 |
| 6-S | 20% NaCl + 5% Crude Glycerol + 1% Sodium Carbonate + 2% |
| | PEG 600 |
| | Curing Solution Ingredients, toggled |
| 1-T | 20% NaCl |
| 2-T | 20% NaCl + 5% Crude Glycerol + 1% Sodium Carbonate |
| 3-T | 20% NaCl + 5% Crude Glycerol + 1% Sodium Carbonate + 2% |
| | PEG 200 |
| 4-T | 20% NaCl + 5% Crude Glycerol + 1% Sodium Carbonate + 2% |
| | PEG 400 |
| 5-T | 20% NaCl + 5% Crude Glycerol + 1% Sodium Carbonate + 2% |
| | PEG 600 |

TABLE 3 (A)
Ash to moisture ratio and the percentage brine saturation of the
cured hide samples after 24 h soaking in alternative brining solutions.

| Curing solution ingredients | % Ash | % Moisture | A:M ratio | BSV |
|---|---|---|---|---|
| 20% NaCl (W/V) at ~45% | 9.47 | 64.03 | 14.8 | 41.22 |
| salt saturation | | | | |
| 20% NaCl; 5% CG; 1% SC | 8.78 | 56.13 | 15.64 | 43.57 |
| 20% NaCl; 5% CG; 1% SC; | 7.98 | 53.09 | 15.02 | 41.84 |
| 2% PEG 200 | | | | |
| 20% NaCl; 5% CG; 1% SC; | 8.01 | 51.72 | 15.49 | 43.13 |
| 2% PEG 400 | | | | |
| 20% NaCl; 5% CG; 1% SC; | 7.44 | 50.89 | 14.62 | 40.73 |
| 2% PEG 600 | | | | |

TABLE 3 (B)
Additional trials using different raw hide sample and a separate
set of brining conditions performed on a different date.

| | | | A/M | |
|---|---|---|---|---|
| Curing solution ingredients | % Ash | % Moisture | ratio | BSV (%) |
| 40% NaCl (W/V) at ~90% | 8.23 | 54.20 | 15.21 | 42.36 |
| salt saturation | | | | |
| 10% NaCl (W/V) at ~33% | 2.71 | 60.92 | 4.45 | 12.40 |
| saturation | | | | |
| 10% NaCl; 5% CG; 1% SC | 2.72 | 57.76 | 4.71 | 13.12 |
| (~33% saturat'n) | | | | |
| 10% NaCl; 5% CG; 1% SC; | 2.53 | 54.15 | 4.68 | 13.03 |
| 2.5% PEG 200 | | | | |
| 10% NaCl; 5% CG; 1% SC; | 2.58 | 55.15 | 4.68 | 13.03 |
| 2.5% PEG 400 | | | | |
| 10% NaCl; 5% CG; 1% SC; | 2.73 | 53.97 | 5.07 | 14.12 |
| 2.5% PEG 600 | | | | |

TABLE 4
Shrinkage temperature of crust leather samples. Concentrations
based on 200% float (W/V). If based on weights of raw hides, all
concentrations should be doubled.

| | | | shrinkage |
|---|---|---|---|
| Sample | drying | | temp |
| code | method | Brining formulation ingredients | (±1° C.) |
| 1-T | toggled | 20% NaCl | 85.5 |
| 2-T | toggled | 20% NaCl, 1% SC, 5% GC | 84.5 |
| 3-T | toggled | 20% NaCl, 1% SC, 5% GC, 2% 200 PEG | 80.5 |
| 4-T | toggled | 20% NaCl, 1% SC, 5% GC, 2% 400 PEG | 82.5 |
| 5-T | toggled | 20% NaCl, 1% SC, 5% GC, 2% 600 PEG | 83.5 |
| 1-S | stacked | 40% NaCl, control-traditional brining | 83.5 |
| 2-S | stacked | 40% NaCl | 83.5 |
| 3-S | stacked | 20% NaCl, 1% SC, 5% GC | 80.5 |
| 4-S | stacked | 20% NaCl, 1% SC, 5% GC, 2% 200 PEG | 85.5 |
| 5-S | stacked | 20% NaCl, 1% SC, 5% GC, 2% 400 PEG | 82.5 |
| 6-S | stacked | 20% NaCl, 1% SC, 5% GC, 2% 600 PEG | 85.5 |

TABLE 5
Mechanical Properties of the finished crust leather from differently cured bovine hides.
All concentrations should be doubled if based on weight of raw hides (% W/W).

| Curing treatments | Tensile Strength, Mpa | Elongation, % | Young's Modulus, MPa | Fracture E, J/cm\hat{ }3 | Toughness Index |
|---|---|---|---|---|---|
| 40% NaCl, std control | 9.8 ± 1.2 | 59.7 ± 5.4 | 10.6 ± 1.3 | 1.99 ± 0.34 | 0.95 ± 0.18 |
| 20% NaCl, control | 9.2 ± 1.6 | 62.2 ± 3.7 | 9.6 ± 1.5 | 1.89 ± 0.29 | 1.15 ± 0.17 |
| #3 = 20% NaCl + 5% CG + | 15.5 ± 1.1 | 66.7 ± 4.9 | 20.1 ± 3.6 | 4.33 ± 0.44 | 0.68 ± 0.24 |
| 1% SC | | | | | |
| #3 + 2% PEG200 | 10.3 ± 1.7 | 63.5 ± 1.7 | 8.8 ± 1.2 | 2.09 ± 0.49 | 1.29 ± 0.22 |
| #3 + 2% PEG400 | 13.7 ± 1.2 | 60.1 ± 4.9 | 20 ± 2.8 | 3.43 ± 0.03 | 0.63 ± 0.12 |
| #3 + 2% PEG600 | 9.5 ± 0.7 | 50.1 ± 2.3 | 11.6 ± 2.3 | 1.73 ± 0.18 | 0.75 ± 0.19 |

TABLE 6
Large scale curing trials performed at the tannery and placed cured hides inside a
humidity and temperature controlled chamber during storage (% W/W)
Ingredients in Curing formulations-based on weight of raw hide
Drm#1-Control (80% NaCl + 0.08% NaHypochlorite + 0.012% degreaser)
Drm #2-low salt control-(20% NaCl + 0.08% NaHypochlorite + 0.012% degreaser)
Drm #3-(20% NaCl + 0.08% NaHypchl + 4% PEG400 + 0.012% degreaser)
Drm#4-(20% NaCl + 0.08% NaHypchl + 4% PEG3300 + 0.012% degreaser)
Drm#5-(20% NaCl + 0.08% NaHypchl + 4% PEG400 + 4% Cr.Glyc + 0.03% KNO₃ + 1% Na₂CO₃)
Drm#6-(20% NaCl + 0.08% NaHypchl + 4% PEG3300 + 4% Cr.Glyc + 0.03% KNO₃ + 1% Na₂CO₃)
Large scale curing trials performed at the tannery and placed cured hides inside a
humidity and temperature controlled chamber during storage (% W/V). concentrations will be
doubled if based on weight of raw hide (% W/W).
Ingredients in Curing formulations-based on volume of solution (200% float)
Drm#1-Control (40% NaCl + 0.04% NaHypochlorite + 0.006% degreaser)
Drm #2-low salt control-(10% NaCl + 0.04% NaHypochlorite + 0.006% degreaser)
Drm #3-(10% NaCl + 0.04% NaHypchl + 2% PEG400 + 0.006% degreaser)
Drm#4-(10% NaCl + 0.04% NaHypchl + 2% PEG3300 + 0.006% degreaser)
Drm#5-(10% NaCl + 0.04% NaHypchl + 2% PEG400 + 2% Cr.Glyc + 0.015% KNO₃ + 0.5% Na₂CO₃)
Drm#6-(10% NaCl + 0.04% NaHypchl + 2% PEG3300 + 2% Cr.Glyc + 0.015% KNO₃ + 0.5% Na₂CO₃)

TABLE 7

| | | |
|---|---|---|
| | Wastewater | Wastewater after 24 h |
| | after 24 h | Rehydration- |
| Cured hide | Curing | 400% float |

| per Table b4 | pH | TDS (ppt)* | pH | TDS (ppt)* |
|---|---|---|---|---|
| Drum #1 | 6.83 | 70 ± 1 | 6.34 | 15 ± 0.4 |
| Drum #2 | 6.92 | 38 ± 0.8 | 6.54 | 7 ± 0.2 |
| Drum #3 | 6.74 | 35 ± 0.5 | 6.31 | 6.7 ± 0.1 |
| Drum #4 | 6.84 | 33 ± 1 | 6.44 | 6.75 ± 0.1 |
| Drum #5 | 9.68 | 31 ± 0.4 | 6.34 | 6.7 ± 0.1 |
| Drum #6 | 9.57 | 32 ± 0.9 | 6.37 | 6.75 ± 0.1 |

*ppt = parts per thousand (1 g/L or 0.5 g/Kg hide);
**ppm = parts per million (1 mg/L or 0.25 mg/Kg hide)

TABLE 8

| | | Sodium | | PEG | PEG | Crude | Sodium | Potassium | | 50 Kg/hides |
|---|---|---|---|---|---|---|---|---|---|---|
| $ price/kg | NaCl | Hypochlrte | degreaser | 400 | 3300 | Glycerol | Carbonate | Nitrate | 1000 kg hides | |
| sple code | 0.21 | 0.3 | 4.5 | 1.9 | 2.1 | 0.48 | 0.25 | 0.8 | $ for ≈ 20hides | $ per hide |
| 1 | 188.28 | 5.17 | 0.54 | 0.00 | 0.00 | 0.00 | 0.00 | 0.00 | 193.99 | 9.70 |
| 2 | 50.40 | 5.16 | 0.53 | 0.00 | 0.00 | 0.00 | 0.00 | 0.00 | 56.09 | 2.80 |
| 3 | 50.42 | 5.15 | 0.55 | 76.00 | 0.00 | 0.00 | 0.00 | 0.00 | 132.12 | 6.61 |
| 4 | 50.54 | 5.19 | 0.54 | 0.00 | 84.22 | 0.00 | 0.00 | 0.00 | 140.49 | 7.02 |
| 5 | 50.42 | 5.17 | 0.00 | 42.35 | 0.00 | 21.40 | 2.23 | 0.11 | 121.68 | 6.08 |
| 6 | 50.42 | 5.17 | 0.00 | 0.00 | 52.55 | 24.02 | 2.50 | 0.12 | 134.77 | 6.74 |

We claim:

1. A method for preserving untanned animal hides comprising contacting the hides with an aqueous suspension containing glycerol, sodium carbonate or sodium bicarbonate, polyethylene glycol, and less than about 25% salt (W/W).

2. The method according to claim 2, wherein said contacting is for at least about 8 hours.

3. The method according to claim 2, wherein said contacting is for no more than about 24 hours.

4. The method according to claim 2, wherein said composition contains no more than about 10% glycerol.

5. The method according to claim 2, wherein said composition contains no more than about 5% W/V sodium carbonate or sodium bicarbonate.

6. The method according to claim 2, wherein said composition contains no more than about 10% polyethylene glycol.

7. The method according to claim 1, wherein said polyethylene glycol has a molecular weight of 600 or less.

8. The method according to claim 1, wherein said polyethylene glycol has a molecular weight of 400 or less.

9. The method according to claim 1, wherein said polyethylene glycol has a molecular weight of 3000 or less.

10. The method according to claim 1, wherein said glycerol is crude glycerol.

11. An aqueous suspension comprising glycerol, sodium carbonate or sodium bicarbonate, polyethylene glycol, and less than about 25% salt (W/W).
